(19) United States
(12) Patent Application Publication
(10) Pub. No.: US 2015/0129511 A1
(43) Pub. Date: May 14, 2015

(54) DISHWASHER APPLIANCE AND A METHOD FOR OPERATING AN APPLIANCE

(71) Applicant: General Electric Company, Schenectady, NY (US)

(72) Inventors: Ramasamy Thiyagarajan, Louisville, KY (US); Adam Christopher Hofmann, Louisville, KY (US)

(73) Assignee: General Electric Company, Schenectady, NY (US)

(21) Appl. No.: 14/075,375

(22) Filed: Nov. 8, 2013

(51) Int. Cl. A47L 15/42; B08B 3/14; C02F 1/00

(52) U.S. Cl. CPC A47L 15/4208; C02F 1/001; B08B 3/14; C02F 2103/002
USPC 210/787; 134/104.4

(57) ABSTRACT

A dishwasher appliance and a method for operating an appliance are provided. The method includes drawing a flow of unfiltered liquid into an unfiltered volume of a filtering assembly of the appliance and circulating the unfiltered liquid in a circular pattern within the unfiltered volume such that the unfiltered liquid circulates in the circular pattern across a filter medium of the filter assembly. The circular pattern of the unfiltered water can assist with limiting or preventing clogging of the filter medium.

### FIELD OF THE INVENTION

The present subject matter relates generally to methods for filtering liquid in appliances, such as dishwasher appliances.

### BACKGROUND OF THE INVENTION

During wash and rinse cycles, dishwashers typically circulate a fluid through a wash chamber over articles such as pots, pans, silverware, and other cooking utensils. The fluid can be e.g., various combinations of water and detergent during the wash cycle or water (which may include additives) during the rinse cycle. Typically the fluid is recirculated during a given cycle using a pump. Fluid is collected at or near the bottom of the wash chamber and pumped back into the chamber through e.g., nozzles in the spray arms and other openings that direct the fluid against the articles to be cleaned or rinsed.

Depending upon the level of soil upon the articles, fluids used during wash and rinse cycles will become contaminated with soils in the form of debris or particles that are carried with the fluid. In order to protect the pump and recirculate the fluid through the wash chamber, it is beneficial to filter the fluid so that relatively clean fluid is applied to the articles in the wash chamber and materials are removed or reduced from the fluid supplied to the pump.

For mechanical filtration, the selectivity of the filter to remove soil particles of different sizes is typically determined by providing fluid paths (such as pores or apertures) through a filter media that are smaller than the particles for which filtration is desired. Particles having a dimension larger than the width of the fluid paths will be trapped or prevented from passing through the filter while particles smaller than the width of the fluid path will generally pass through. Some particle sizes and/or types may be not harmful to the pump or spray assemblies and, therefore, can be allowed to pass into the pump inlet. However, while some smaller particles may not be harmful to the pump, leaving such particles in the wash or rinse fluid may not be acceptable as these particles may become deposited on the articles being washed/rinsed and thereby affect the user's perception of the cleanliness and/or appearance.

While larger particles can generally be readily removed from the fluid circulated through the wash chamber, challenges are presented in removing smaller particles—particularly as the particle size targeted for removal decreases. For example, if a dishwashing appliance is provided with a fine particle filter—such as one for removing particles 200 microns or larger—the filter can be prone to clogging particularly during the early stages of the cleaning process. During a pre-wash cycle or early stage of a wash cycle, a greater amount of larger food particles may be present on the articles placed in the wash chamber. A fine particle filter—such as one for removing particles 200 microns are larger—may become substantially clogged.

To unclog the filter, a conventional approach has been to drain the dirty fluid from the wash chamber to remove the particles clogging the filter. New—i.e. clean fluid—is then reintroduced for cycling again. Depending on the level of soil still present on the articles, yet another cycle of draining and refilling may have to be repeated. Unfortunately, this run, drain, and refill approach for unclogging a filter is inefficient as it requires the use of additional fluid (i.e. water). Of course, a filter media can be selected that only captures larger particles so that it clogs less, such as e.g., 0.030″ or larger, but this comes at the expense of losing the ability to remove smaller particles from the fluid and an associated effect on the resulting cleanliness of the articles.

Another challenge with filtration of the wash fluid is servicing of the filter and, more particularly, the filter media. Sometimes, for example, food particles can become lodged in the filter requiring that the filter be removed and either manually cleaned or replaced. Certain conventional dishwashing appliances do not have a filter that is readily accessible to the user and/or otherwise readily cleanable or serviceable.

Accordingly, a dishwasher appliance having filtering system for the removal of particles from the wash fluid would be useful. More particularly, a dishwasher appliance having filtering system for the removal of particles from the wash fluid while that also includes features for limiting clogging of the filtering system would be useful.

### BRIEF DESCRIPTION OF THE INVENTION

The present subject matter provides a dishwasher appliance and a method for operating an appliance. The method includes drawing a flow of unfiltered liquid into an unfiltered volume of a filtering assembly of the appliance and circulating the unfiltered liquid in a circular pattern within the unfiltered volume such that the unfiltered liquid flows in the circular pattern across a filter medium of the filter assembly. The circular pattern of the unfiltered water can assist with limiting or preventing clogging of the filter medium. Additional aspects and advantages of the invention will be set forth in part in the following description, or may be apparent from the description, or may be learned through practice of the invention.

In a first exemplary embodiment, a dishwasher appliance is provided. The dishwasher appliance includes a tub that defines a wash chamber. The tub has a sump positioned at a bottom portion of the tub. A filter assembly defines a filtered volume and an unfiltered volume. A filter medium of the filter assembly is disposed between the filtered volume and the unfiltered volume. The unfiltered volume has an entrance. The entrance of the unfiltered volume is in fluid communication with the sump of the tub such that the unfiltered volume is configured for receipt of liquid from the sump of the tub. The unfiltered volume is shaped and oriented for circulating the liquid in a circular pattern across the filter medium of the filter assembly.

In a second exemplary embodiment, a method for operating an appliance is provided. The method includes drawing a flow of unfiltered liquid into an unfiltered volume of a filtering assembly of the appliance and circulating the unfiltered liquid in a circular pattern within the unfiltered volume such that the unfiltered liquid flows in the circular pattern across a filter medium of the filter assembly.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front elevation view of a dishwasher appliance according to an exemplary embodiment of the present subject matter.

FIG. 2 provides a side, section view of the exemplary dishwasher appliance of FIG. 1.

FIG. 3 provides a schematic view of a sump and filter assembly according to an exemplary embodiment of the present subject matter.

FIG. 4 provides a schematic view of certain components of the exemplary filter assembly of FIG. 3.

FIGS. 5 and 6 provide partial, perspective views of a sump assembly according to an exemplary embodiment of the present subject matter.

FIGS. 7 and 8 provide perspective views of certain components of the exemplary sump assembly of FIGS. 5 and 6.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

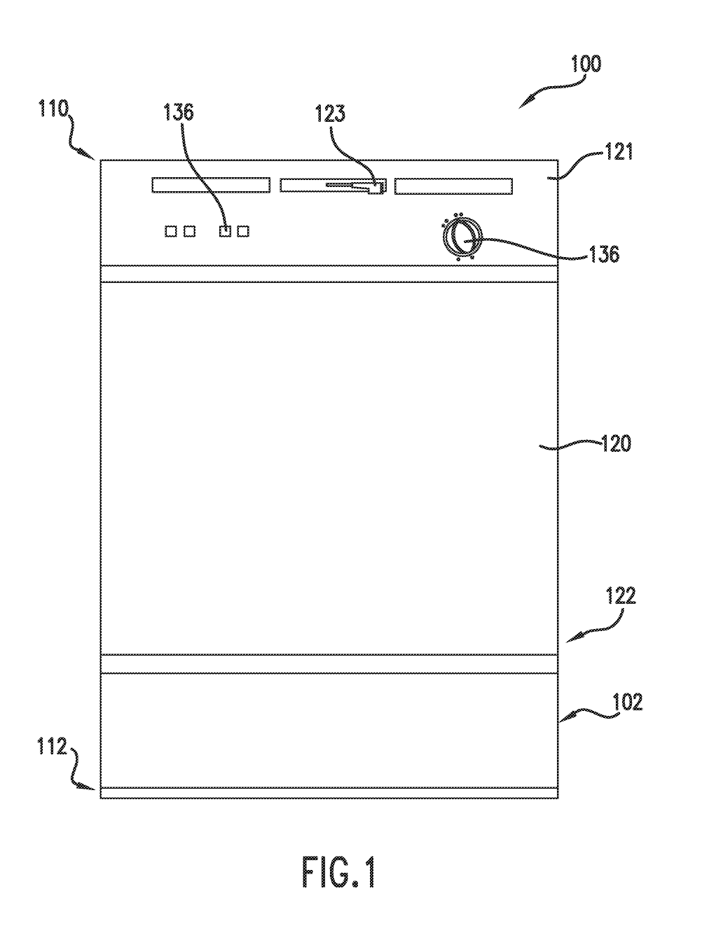

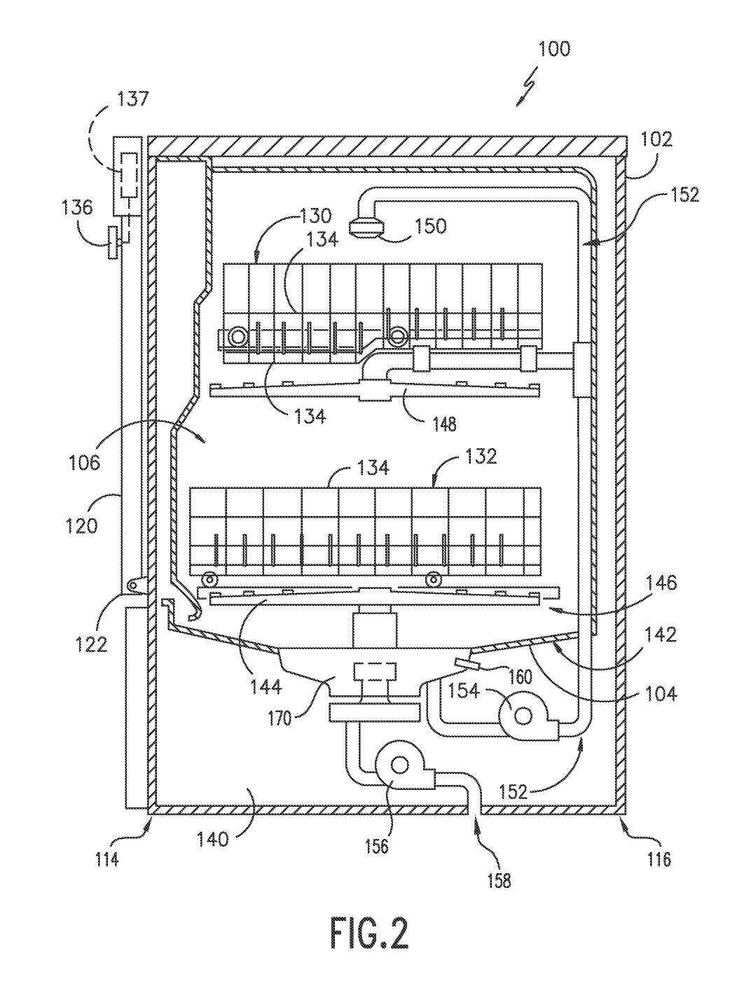

FIGS. 1 and 2 depict a dishwasher appliance 100 according to an exemplary embodiment of the present subject matter. As shown in FIG. 1, dishwasher appliance 100 includes a cabinet 102 that extends between a front portion 114 and a back portion 116. Cabinet 102 also extends between a top portion 110 and a bottom portion 112. Cabinet 102 has a tub 104 therein that defines a wash compartment 106. The tub 104 also defines a front opening (not shown). Dishwasher appliance 100 includes a door 120 hinged at a bottom 122 of door 120 for movement between a normally closed, vertical position (shown in FIGS. 1 and 2), wherein wash compartment 106 is sealed shut for washing operation, and a horizontal, open position for loading and unloading of articles from dishwasher appliance 100. Latch 123 is used to lock and unlock door 120 for access to wash compartment 106. Tub 104 also includes a sump assembly 170 positioned adjacent bottom portion 112 of cabinet 102 and configured for receipt of a liquid (e.g., water, detergent, wash fluid, and/or any other suitable fluid) during operation of dishwasher appliance 100.

A spout 160 is positioned adjacent sump assembly 170 of dishwasher appliance 100. Spout 160 is configured for directing liquid into sump assembly 170. Spout 160 may receive liquid from, e.g., a water supply (not shown) or any other suitable source. In alternative embodiments, spout 160 may be positioned at any suitable location within dishwasher appliance 100 such that spout 160 directs liquid into tub 104. Spout 160 may include a valve (not shown) such that liquid may be selectively directed into tub 104. Thus, for example, during the cycles described below, spout 160 may selectively direct water and/or wash fluid into sump assembly 170 as required by the current cycle of dishwasher appliance 100.

Rack assemblies 130 and 132 are slidably mounted within wash compartment 106. Each of the rack assemblies 130 and 132 is fabricated into lattice structures including a plurality of elongated members 134. Each rack of the rack assemblies 130 and 132 is adapted for movement between an extended loading position (not shown) in which the rack is substantially positioned outside the wash compartment 106, and a retracted position (shown in FIGS. 1 and 2) in which the rack is located inside the wash compartment 106. A silverware basket (not shown) may be removably attached to rack assembly 132 for placement of silverware, utensils, and the like, that are otherwise too small to be accommodated by the racks 130, 132.

Dishwasher appliance 100 further includes a lower spray assembly 144 that is rotatably mounted within a lower region 146 of the wash compartment 106 and above a tub sump portion 142 so as to rotate in relatively close proximity to rack assembly 132. A mid-level spray assembly 148 is located in an upper region of the wash compartment 106 and may be located in close proximity to upper rack 130. Additionally, an upper spray assembly 150 may be located above the upper rack 130.

The lower and mid-level spray assemblies 144, 148 and the upper spray assembly 150 are fed by a fluid circulation assembly 152 for circulating water and dishwasher fluid in the tub 104. Fluid circulation assembly 152 may include a recirculation pump 154 and a drain pump 156 located in a machinery compartment 140 located below tub sump portion 142 of the tub 104, as generally recognized in the art. Drain pump 156 is configured for urging wash fluid within sump assembly 170 out of tub 104 and dishwasher appliance 100 to a drain 158. Recirculation assembly 154 is configured for supplying a flow of wash fluid from sump assembly 170 to spray assemblies 144, 148 and 150.

Each spray assembly 144 and 148 includes an arrangement of discharge ports or orifices for directing wash fluid onto dishes or other articles located in rack assemblies 130 and 132. The arrangement of the discharge ports in spray assemblies 144 and 148 provides a rotational force by virtue of wash fluid flowing through the discharge ports. The resultant rotation of the lower spray assembly 144 provides coverage of dishes and other dishwasher contents with a spray of wash fluid.

Dishwasher appliance 100 is further equipped with a controller 137 to regulate operation of the dishwasher appliance 100. Controller 137 may include a memory and microprocessor, such as a general or special purpose microprocessor operable to execute programming instructions or micro-control code associated with a cleaning cycle. The memory may represent random access memory such as DRAM, or read only memory such as ROM or FLASH. In one embodiment, the processor executes programming instructions stored in memory. The memory may be a separate component from the processor or may be included onboard within the processor. Alternatively, controller 137 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

Controller 137 may be positioned in a variety of locations throughout dishwasher appliance 100. In the illustrated embodiment, controller 137 may be located within a control panel area 121 of door 120 as shown. In such an embodiment, input/output (“I/O”) signals may be routed between the control system and various operational components of dishwasher appliance 100 along wiring harnesses that may be routed through the bottom 122 of door 120. Typically, controller 137 includes a user interface panel 136 through which a user may select various operational features and modes and monitor progress of the dishwasher appliance 100. In one embodiment, user interface 136 may represent a general purpose I/O (“GPIO”) device or functional block. In one embodiment, user interface 136 may include input components, such as one or more of a variety of electrical, mechanical or electro-mechanical input devices including rotary dials, push buttons, and touch pads. User interface 136 may include a display component, such as a digital or analog display device designed to provide operational feedback to a user. User interface 136 may be in communication with controller 137 via one or more signal lines or shared communication busses.

It should be appreciated that the subject matter disclosed herein is not limited to any particular style, model, or other configuration of dishwasher, and that the embodiment depicted in FIGS. 1 and 2 is for illustrative purposes only. For example, instead of the racks 130, 132 depicted in FIG. 1, dishwasher appliance 100 may be of a known configuration that utilizes drawers that pull out from the cabinet and are accessible from the top for loading and unloading of articles.

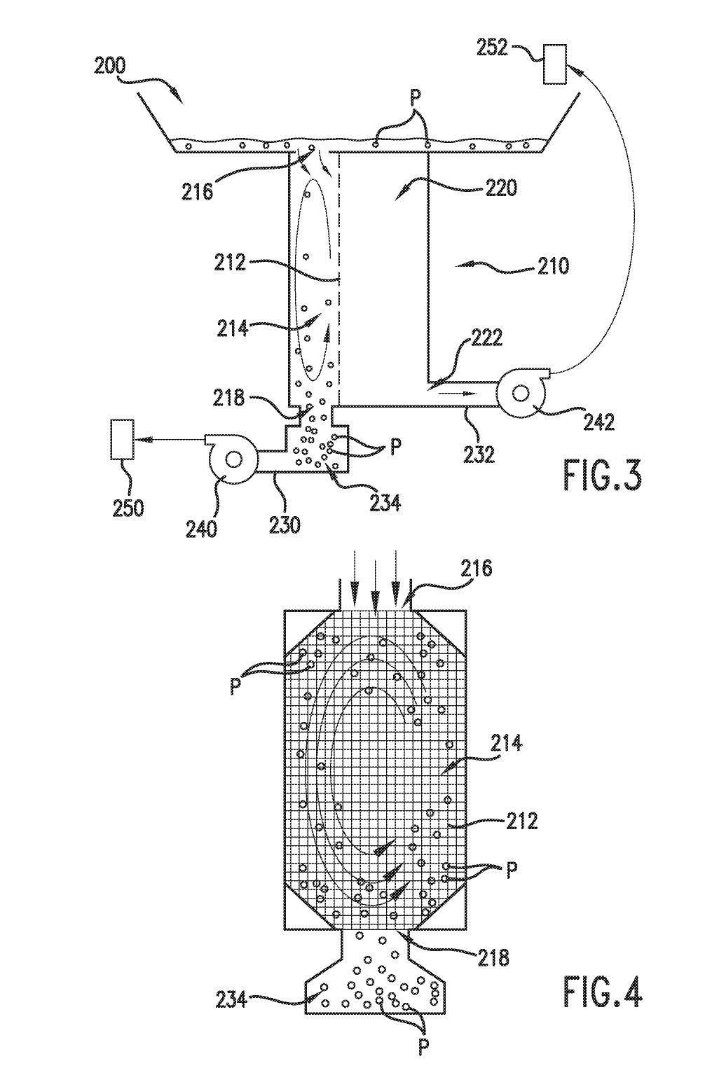

FIG. 3 provides a schematic view of a sump 200 and filter assembly 210 according to an exemplary embodiment of the present subject matter. FIG. 4 provides a schematic view of certain components of filter assembly 210. Sump 200 and filter assembly 210 can be used in any suitable appliance. For example, sump 200 and filter assembly 210 may be used in dishwasher appliance 100 (FIG. 2), e.g., as sump assembly 170. In dishwasher appliance 100, filter assembly 210 can filter liquid passing therethrough and supply such filtered liquid to at least one of spray assemblies 144, 148 and 150. Filtering liquid supplied to spray assemblies 144, 148 and 150 can assist with limiting or preventing clogging of spray assemblies 144, 148 and 150.

As may be seen in FIGS. 3 and 4, filter assembly 210 includes a filter medium 212 and defines an unfiltered volume 214 and a filtered volume 220. During operation filter assembly 210, filter medium 212 is fixed or static. Filter medium 212 is disposed between filtered volume 220 and unfiltered volume 214. As used herein, the term “unfiltered” describes a volume that is not filtered relative to filter medium 212 and the term “filtered” describes a volume that is filtered relative to filter medium 212. However, as will be understood by those skilled in the art, filter assembly 210 may include additional filters, such as a coarse filter, that filter liquid entering unfiltered volume 214. Thus, unfiltered volume 214 may be filtered relative to other filters but not filter medium 212.

Unfiltered volume 214 has an entrance 216 and an exit 218. Entrance 216 of unfiltered volume 214 is in fluid communication with sump 200. Thus, unfiltered volume 214 is configured for receipt of liquid from sump 200, and liquid in sump 200 can flow into unfiltered volume 214 via entrance 216 of unfiltered volume 214. As discussed in greater detail below, liquid in unfiltered volume 214 may pass or flow through filter medium 212 into filtered volume 220. Filter medium 212 removes debris or particles P from liquid passing through filtering medium 212 from unfiltered volume 214 to filtered volume 220. Thus, unfiltered liquid passes though filter medium 212 to remove debris or particles P and exits filter medium 212 into filtered volume 220 as filtered liquid. Filtered volume 220 also includes an exit 222. Filtered liquid within filtered volume 220 flows out of filtered volume 220 via exit 222 of filtered volume 220. In such a manner, unfiltered liquid follows a path through filter assembly 210. In particular, unfiltered liquid passes though filter medium 212, and filtered liquid exits filter assembly 210. Such filtering can assist with limiting or preventing clogs in associated spray assemblies of an appliance.

Filter assembly 210 also includes a collection chamber 234. Debris or particles P collect or settle within collection chamber 234, e.g., during operation of filter assembly 210. In addition, liquid in unfiltered volume 214 may also pass or flow into collection chamber 234 via exit 218 of unfiltered volume 214. Thus, filter assembly 210 and/or sump 200 may be drained of liquid by directing liquid out of unfiltered volume 214 via exit 218 of unfiltered volume 214. The drained liquid may be directed to a drain and an associated septic or sewer system.

As may be seen in FIGS. 3 and 4, unfiltered liquid circulates in a circular pattern within unfiltered volume 214 such that the unfiltered liquid flows in the circular pattern across filter medium 212 within unfiltered volume 214, e.g., about an axis that is perpendicular to an outer surface of filter medium 212. The circular flow of liquid within unfiltered volume 214 can assist with limiting or preventing clogging or saturation of filter media 212 with debris or particles P. The circular cross flow can also assist with flushing filter media 212 of debris or particles P and/or limiting collection of debris or particles P within filter media 212. In particular, the circular cross flow can limit collection of debris or particles P at a central portion of filter media 212 as shown in FIG. 4.

Unfiltered volume 214 is shaped and oriented for circulating liquid within unfiltered volume 214 in the circular pattern across filter medium 212. During circulation of unfiltered liquid within unfiltered volume 214, debris or particles P settle within collecting chamber 234, e.g., due to centrifugal force acting on debris or particles P within the circulating unfiltered liquid in unfiltered volume 214. Collection chamber 234 may be positioned for collecting debris or particles P from the unfiltered liquid during circulation of the unfiltered liquid within unfiltered volume 214. For example, collection chamber 234 may be disposed, e.g., directly, below unfiltered volume 214.

Filter assembly 210 also includes a first pump 240, a second pump 242, an exit conduit 230 and a recirculation conduit 232. Exit conduit 230 extends from collection chamber 234 to first pump 240. First pump 240 is operable to draw liquid from collection chamber 234 to or towards first pump 240 via exit conduit 230. First pump 240 can be any suitable pump. For example, when used in dishwasher appliance 100 (FIG. 1), first pump 240 may be drain pump 156. Exit conduit 230 may also extend from collection chamber 234 to a drain 250. Thus, exit conduit 230 can be arranged or configured for directing liquid and debris or particles P from collection chamber 234 to drain 250, e.g., during operation of first pump 240.

Recirculation conduit 232 extends from exit 222 of filtered volume 220 to second pump 242. Second pump 242 is operable to draw liquid from filtered volume 220 to or towards second pump 242 via recirculation conduit 232. Second pump 242 can be any suitable pump. For example, when used in dishwasher appliance 100 (FIG. 1), second pump 242 may be recirculation pump 154. Recirculation conduit 232 may also extend from exit 222 of filtered volume 220 to a spray assembly 252 positioned above or within sump 200. Thus, recirculation conduit 232 can be arranged or configured for directing liquid from filtered volume 220 to spray assembly 252, e.g., during operation of second pump 242. When used in dishwasher appliance 100, recirculation conduit 232 can be arranged or configured for directing liquid from filtered volume 220 to at least one of spray assemblies 144, 148 and 150, e.g., during operation of recirculation pump 154.

Second pump 242 may be operated intermittently during a filtering operation to circulate liquid within unfiltered volume 214 in the circular pattern across filter medium 212 and draw liquid though filter media 212 into filtered portion 220. Similarly, first pump 240 may be operated intermittently during a filtering operation to remove liquid and debris or particles P from collection chamber 234. For example, second pump 242 may be operated for a first period of time in order to circulate liquid within unfiltered volume 214 in the circular pattern across filter medium 212 and draw liquid though filter media 212 into filtered portion 220. After the first period of time has elapsed, the second pump 242 may be deactivated. After a delay to allow for debris or particles P to settle within collection chamber 234, first pump 240 may be operated for a second period of time to remove liquid and debris or particles P from collection chamber 234. After the second period of time has elapsed, second pump 242 may be reactivated to circulate liquid within unfiltered volume 214 in the circular pattern across filter medium 212 and draw liquid though filter media 212 into filtered portion 220. Thus, first and second pumps 240 and 242 may be operated successively or consecutively in order to filter liquid within filter assembly 210 and remove debris or particles P from filter assembly 210. First pump 240 may also be operated at an end of a wash cycle, e.g., to drain collection chamber 234 of debris or particles P. First pump 240 may be operated to partially or fully drain collection chamber 234 of liquid during the wash cycle. Controller 137 or a similar device may be programmed or configured to operate first and second pumps 240 and 242 in such a manner.

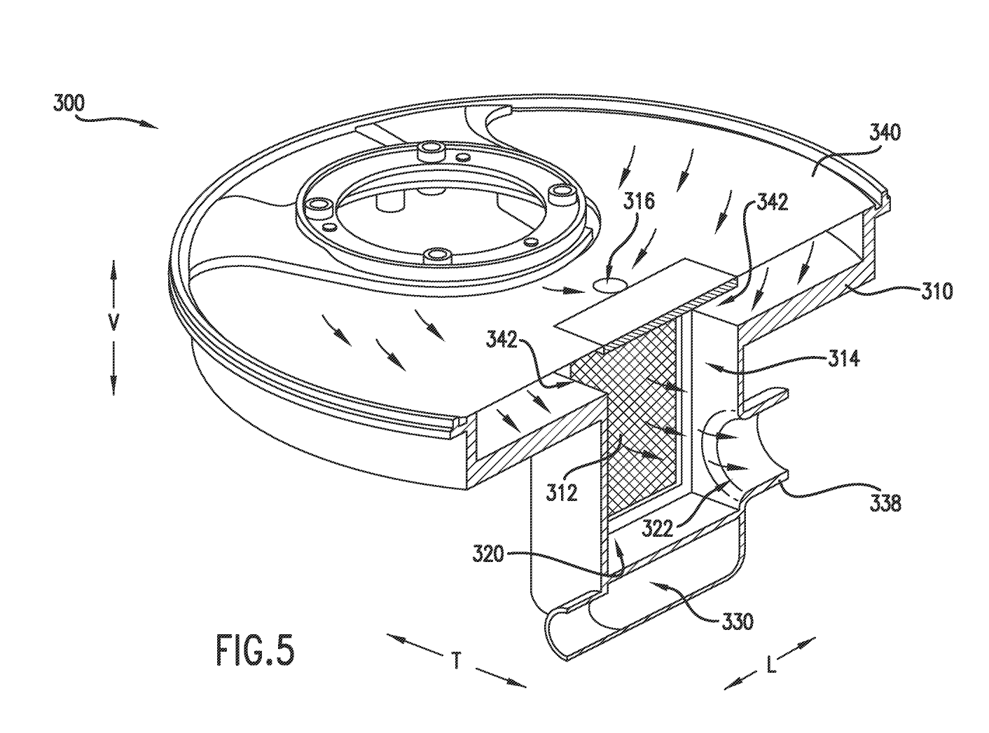

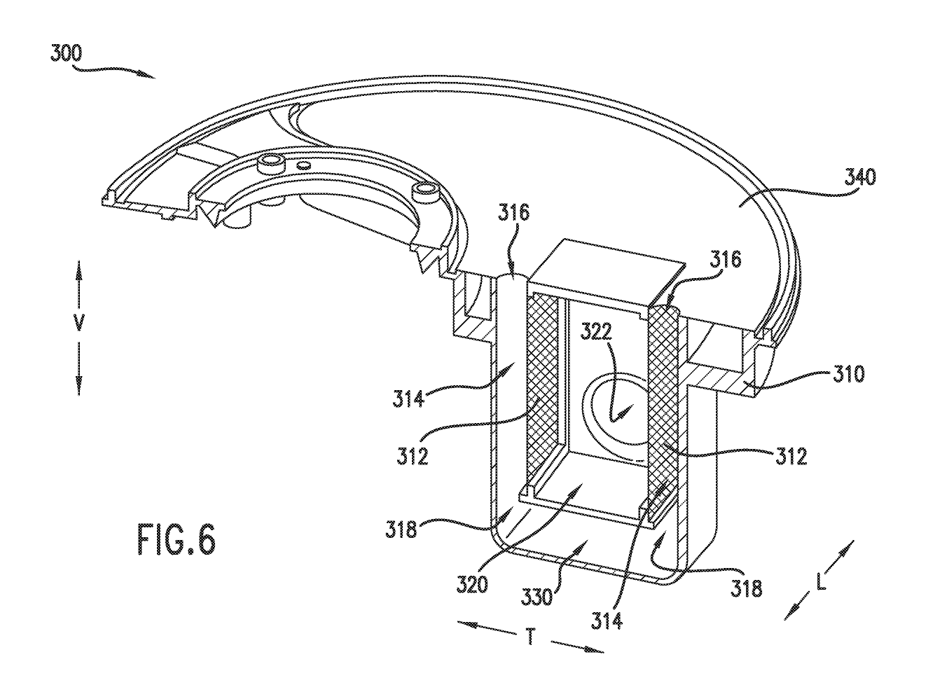

FIGS. 5 and 6 provide partial, perspective views of a sump assembly 300 according to an exemplary embodiment of the present subject matter. Sump assembly 300 can be used in any suitable appliance. For example, sump assembly 300 may be used in dishwasher appliance 100 (FIG. 2), e.g., as sump assembly 170. In dishwasher appliance 100, sump assembly 300 can assist with filtering liquid passing therethrough and supply such filtered liquid to at least one of spray assemblies 144, 148 and 150. Filtering liquid supplied to spray assemblies 144, 148 and 150 can assist with limiting or preventing clogging of spray assemblies 144, 148 and 150. Sump assembly 300 defines a vertical direction V, a lateral direction L and a transverse direction T. The vertical direction V, the lateral direction L and the transverse direction T are mutually perpendicular and form an orthogonal direction system.

Sump assembly 300 includes a main body 310 and filter media 312. Filter media 312 are, e.g., removably, mounted to main body 310. Within main body 310, filter media 312 assist with defining an unfiltered volume 314 and a filtered volume 320. In particular, filter media 312 are disposed between unfiltered volume 314 and filtered volume 320. Unfiltered volume 314 has a plurality of entrances 316 and a plurality of exits 318. Entrances 316 of unfiltered volume 314 may be positioned or arranged for receipt of liquid, e.g., during operation of an associated appliance. Thus, unfiltered volume 314 is configured for receipt of unfiltered liquid, and such unfiltered liquid can flow into unfiltered volume 314 via entrance 316 of unfiltered volume 314.

As discussed in greater detail below, unfiltered volume 314 is shaped and oriented for circulating liquid within unfiltered volume 314 in a circular pattern across filter media 312. A collection chamber 330 is disposed below unfiltered volume 314, e.g., along the vertical direction V. Collection chamber 330 is positioned for collecting debris or particles P from liquid within unfiltered volume 314 during circulation of the liquid within unfiltered volume 314, e.g., due to due to centrifugal force acting on the debris or particles P within the circular flow of liquid in unfiltered volume 314. Liquid and debris or particles P within collection chamber 330 may be directed out of collection chamber 330 via an exit conduit 336.

As discussed in greater detail below, liquid in unfiltered volume 314 can pass or flow through filter media 312 into filtered volume 320. Filter media 312 removes debris or particles P from liquid passing through filtering media 312 from unfiltered volume 314 to filtered volume 320. Thus, unfiltered liquid passes though filter media 312 to remove debris or particles P and exits filter media 312 into filtered volume 320 as filtered liquid. Filtered volume 320 also includes an exit 322. Filtered liquid within filtered volume 320 then flows out of filtered volume 320 via exit 322 of filtered volume 320, e.g., to a recirculation conduit 338.

Sump assembly 300 also includes a coarse filter 340. Coarse filter 340 also filters liquid within sump assembly 300. For example, coarse filter 340 filters liquid prior to such liquid entering filtered volume 320 via bypass inlets 342. Thus, if filter media 312 is clogged or obstructed liquid can continue to flow into filtered volume 320 via bypass inlets 342. Coarse filter 340 can be any suitable size or shape.

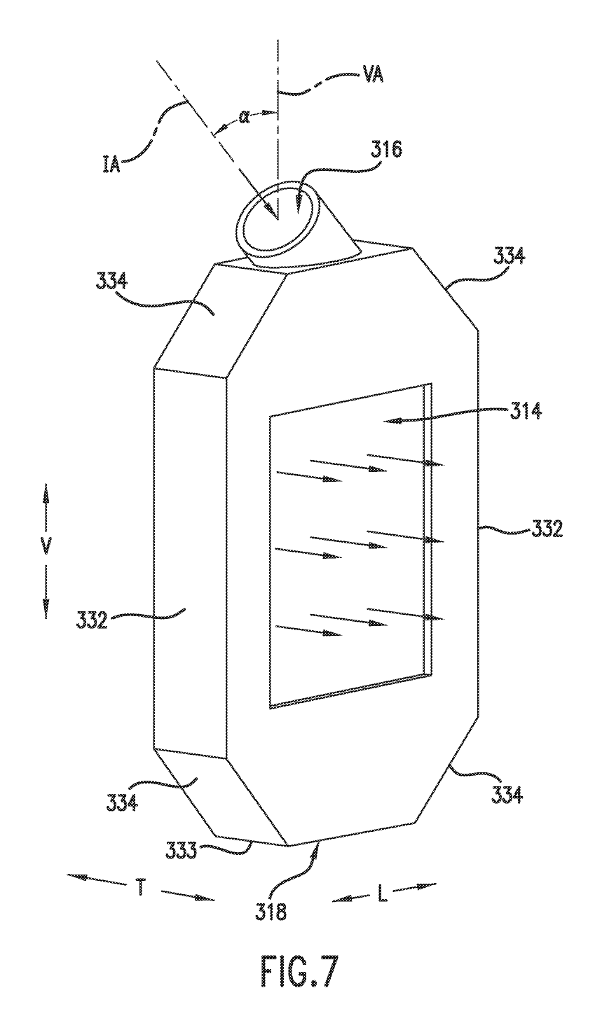

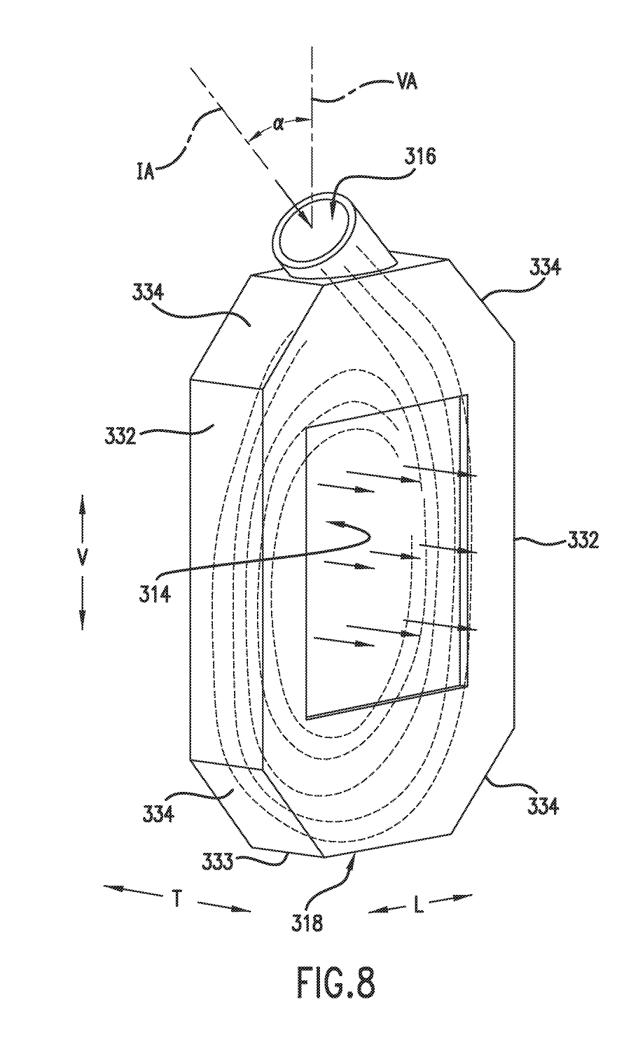

FIGS. 7 and 8 provide perspective views of certain components of sump assembly 300. In particular, components of sump assembly 300 that assist with defining unfiltered volume 314 and with circulating unfiltered liquid in a circular pattern across filter media 312 within unfiltered volume 314 as shown in FIGS. 7 and 8. The circular flow of liquid within unfiltered volume 314 can assist with limiting or preventing clogging or saturation of filter media 312 with debris or particles P. The circular cross flow can also assist with flushing filter media 312 of debris or particles P and/or limiting collection of debris or particles P within filter media 312.

Entrance 316 of unfiltered volume 314 is positioned and oriented for assisting with circulating unfiltered liquid in a circular pattern across filter media 312 within unfiltered volume 314. In particular, entrance 316 of unfiltered volume 314 defines an inclined central axis IA. Thus, a flow of unfiltered liquid entering unfiltered volume 314 via entrance 316 can enter unfiltered volume 314 at an incline relative to a vertical axis VA. Inclined central axis IA may pass through centroids of entrance 316 of unfiltered volume 314, e.g., in planes that are perpendicular to a flow of liquid into unfiltered volume 314 through entrance 316. Also, inclined central axis IA may be substantially parallel to the flow of liquid into unfiltered volume 314 through entrance 316. Inclined central axis IA and vertical axis VA (e.g., that is parallel to the vertical direction V) can define an angle α therebetween. The angle α can be any suitable angle. For example, the angle α may be greater than about thirty degrees and less than about sixty degrees. As an additional example, the angle α may be greater than about zero degrees and less than about ninety degrees. As another example, the angle α may be about forty-five degrees.

An area of entrance 316, e.g., in a plane that is perpendicular to the inclined central axis IA may be less than an area of unfiltered volume 314, e.g., in a plane that is perpendicular to a vertical axis VA. Thus, liquid flowing into unfiltered volume 314 can decrease in velocity. In particular, the expanded cross-sectional area of unfiltered column 314 relative to entrance 316 can assist with decreasing the velocity of liquid entering unfiltered volume 314.

In FIGS. 7 and 8, entrance 316 has a substantially circular shape, e.g., in a plane that is perpendicular to the inclined central axis IA. It should be understood that entrance 316 can have any suitable shape in alternative exemplary embodiments. For example, entrance 316 may have a substantially rectangular shape or a substantially oval shape, e.g., in a plane that is perpendicular to the inclined central axis IA.

Unfiltered volume 314 is also shaped to assist with circulating unfiltered liquid in a circular pattern across filter media 312 within unfiltered volume 314. In particular, unfiltered volume 314 defines an octagonal shape, circular shape or oval shape, e.g., in a plane that is perpendicular to a tangent line of filter media 312, the lateral direction L or the transverse direction T. In particular, sump assembly 300 includes sidewalls 332 and angled portions 334 that assist with defining unfiltered volume 314. Surfaces of angled portions 334 may be angled relative to surfaces of sidewalls 332, and such angling can assist with directing the unfiltered liquid within unfiltered volume 314 in a circular pattern across filter media 312. In particular, sidewalls 332 may meet angled portions 334 at an angle less than ninety degrees. For example, sidewalls 332 may meet angled portions 334 at an angle greater than about thirty degrees and less than about sixty degrees. As another example, sidewalls 332 may meet angled portions 334 at an angle of about forty-five degrees.

As may be seen in FIG. 8, a flow of unfiltered liquid entering unfiltered volume 314 via entrance 316 may be directed towards one of sidewalls 332, e.g., rather than a bottom wall 333 of sump assembly 300. Thus, entrance 316 of unfiltered volume 314 may be positioned and oriented for directing the flow of unfiltered liquid entering unfiltered volume 314 via entrance 316 towards one of sidewalls 332. In addition, the flow of unfiltered liquid entering unfiltered volume 314 via entrance 316 may be substantially parallel to one of angled portions 334. Thus, entrance 316 of unfiltered volume 314 may be positioned and oriented such that the flow of unfiltered liquid entering unfiltered volume 314 via entrance 316 is substantially parallel to one of angled portions 334. Such positioning and orienting can assist with circulating unfiltered liquid in a circular pattern across filter media 312 within unfiltered volume 314.

Filter media 312 can be any suitable filtering material or mechanism. For example, filter media 312 may be a plastic or metal mesh. In particular, filter media 312 may include a plurality of substantially flat or planar sheets that are spaced apart from each other, e.g., along the transverse direction T, as shown in FIG. 6. The filter media 312 can include any suitable number of substantially flat or planar sheets. For example, filter media 312 may include at least two substantially flat or planar sheets or at least four substantially flat or planar sheets. By including multiple substantially flat or planar sheets, a filtering capacity of sump assembly 300 can be increased or improved relative to a single sheet.

Filter media 312 can be configured for fine filtration—e.g. filtering of relatively small particles. Accordingly, in one exemplary aspect of the present subject matter, filter media 312 may be configured (e.g., define holes or apertures) for removing particles in the size range of about fifty microns to about four hundred microns. For example, filter media 312 may be a screen or mesh having holes in the size range of about fifty microns to about four hundred microns. In another exemplary aspect of the present subject matter, filter media 312 may be configured (e.g., define holes or apertures) for removing particles in the size range of about three hundred microns to about six hundred microns. For example, filter media 312 may be a screen or mesh having holes in the size range of about three hundred microns to about six hundred microns. These size ranges are provided by way of example only. Other ranges may be used in certain exemplary embodiments of the present subject matter as well.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A dishwasher appliance, comprising:
a tub defining a wash chamber, the tub having a sump positioned at a bottom portion of the tub;
a filter assembly defining a filtered volume and an unfiltered volume, a filter medium of the filter assembly disposed between the filtered volume and the unfiltered volume, the unfiltered volume having an entrance, the entrance of the unfiltered volume being in fluid communication with the sump of the tub such that the unfiltered volume is configured for receipt of liquid from the sump of the tub, the unfiltered volume shaped and oriented for circulating the liquid in a circular pattern across the filter medium of the filter assembly.

2. The dishwasher appliance of claim 1, wherein the filter assembly includes a collection chamber disposed below the unfiltered volume, the collection chamber positioned for collecting food particles from the liquid during circulation of the liquid within the unfiltered volume.

3. The dishwasher appliance of claim 2, further comprising a drain pump and a drain conduit, the drain conduit extending between the collection chamber and the drain pump, the drain pump operable to urge liquid and food particles from the collection chamber via the drain conduit.

4. The dishwasher appliance of claim 3, further comprising a recirculation pump and a recirculation conduit, the recirculation conduit extending between the filtered volume and the recirculation pump, the recirculation pump operable to urge liquid from the filtered volume via the recirculation conduit.

5. The dishwasher appliance of claim 4, further comprising a spray assembly positioned within the wash chamber of the tub, the recirculation conduit extending between the recirculation pump and the spray assembly, the recirculation pump operable to urge liquid from the filtered volume to the spray assembly via the recirculation conduit.

6. The dishwasher appliance of claim 1, wherein the entrance of the unfiltered volume defines an inclined central axis.

7. The dishwasher appliance of claim 6, wherein the inclined central axis and a vertical axis define an angle α therebetween, the angle α being greater than about zero degrees and less than about ninety degrees.

8. The dishwasher appliance of claim 6, wherein an area of the entrance in a plane that is perpendicular to the inclined central axis is less than an area of the unfiltered volume in a plane that is perpendicular to a vertical axis.

9. The dishwasher appliance of claim 1, wherein the unfiltered volume defines an octagonal shape, a circular shape or an oval shape in a plane that is perpendicular to a tangent line of the filter medium.

10. The dishwasher appliance of claim 1, wherein the filter medium comprises a vertically oriented substantially flat screen.

11. A method for operating an appliance, comprising:
drawing a flow of unfiltered liquid into an unfiltered volume of a filtering assembly of the appliance; and
circulating the unfiltered liquid in a circular pattern within the unfiltered volume such that the unfiltered liquid flows in the circular pattern across a filter medium of the filter assembly.

12. The method of claim 11, wherein said step of directing comprises operating a recirculation pump of the appliance in order to draw the flow of unfiltered liquid into the unfiltered volume of the filtering assembly.

13. The method of claim 11, further comprising collecting food particles within a collection chamber of the filtering assembly during said step of circulating.

14. The method of claim 13, further comprising activating a drain pump in order to urge the unfiltered liquid and the food particles from collection chamber.

15. The method of claim 11, wherein said step of activating comprises activating the drain pump after said step of circulating in order to urge the unfiltered liquid and the food particles from collection chamber.

16. The method of claim 11, wherein said step of drawing comprises operating a recirculation pump.

17. The method of claim 16, further comprising directing filtered liquid from a filtered volume of the filtering assembly to a spray assembly of the appliance with the recirculation pump.

18. The method of claim 11, further comprising directing liquid through the filtering medium to a filtered volume during said step of circulating.

19. The method of claim 11, wherein the flow of unfiltered liquid decreases in velocity as the flow of unfiltered liquid enters the unfiltered volume of the filtering assembly during said step of drawing.

20. The method of claim 11, wherein the flow of unfiltered liquid enters the unfiltered volume of the filtering assembly at an incline relative to a vertical axis.
